(19) United States
(12) Patent Application Publication
(10) Pub. No.: US 2008/0190166 A1
(43) Pub. Date: Aug. 14, 2008

(54) Device and Method for Error-Protected Detection of Measured Values in a Control Unit

(76) Inventors: Ulrich Hahn, Neustadt/A (DE); Andreas Kuhn, Erlangen (DE); Christoph Nolting, Hochstadt/Aisch (DE); Bernd Quaschner, Grossenseebach (DE); Johannes Welker, Neumarkt (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/579,430

(22) PCT Filed: Apr. 26, 2005
(86) PCT No.: PCT/EP05/51860

§ 371 Date: Jan. 4, 2008

(30) Foreign Application Priority Data
May 3, 2004 (DE) 10 2004 021 635.5

(51) Int. Cl. G12B 13/00

(52) U.S. Cl. 73/1.01

(57) ABSTRACT

In one aspect a device to simplify, and to reduce the costs of, the error-protected detection of the measured values in the control unit, without reducing the error protection of the system is provided. The device includes a pick-up device for detecting measuring signals. Independently operating evaluation devices are provided for the redundant determination of measured values from the measuring signals of the pick-up device. The data is transmitted to the control unit by means of error-protected transmission devices. A first evaluation device is used to determine a measured value, and a second evaluation device is used to determine a less precise, coarse comparison value. The device is also used to establish the accuracy of the measured value by comparing the value with the comparison value.

### CROSS REFERENCE TO RELATED APPLICATIONS

This application is the US National Stage of International Application No. PCT/EP2005/051860 filed Apr. 26, 2005 and claims the benefit thereof. The International Application claims the benefits of German application No. 102004021635.5 DE filed May 3, 2004, both of the applications are incorporated by reference herein in their entirety.

### FIELD OF INVENTION

The present invention relates to a device and a method for error-protected detection of measured values in a control unit.

### BACKGROUND OF INVENTION

For controlling drives in a wide variety of areas of application the most precise determination possible of the position or speed of the driven control element or of the drive device of the control element is needed. In particular a precise distinction must be made between a shaft which has come to a standstill and one which is rotating slowly. End positions and other safety-relevant settings and operating states must also be detected reliably and in a failsafe manner. To this end there must be error-protected detection and evaluation of the signals, so that the operational safety of the device is guaranteed. As a rule the speed is obtained in such cases by numerical derivation of positional values.

This operational safety is achieved especially by redundant provision of pickup devices and evaluation devices, with corresponding comparison and voting devices being used to draw conclusions about the error-free state of the measured values created from the measuring signals of the pick-up device and the transmitted data and if necessary to draw conclusions from the error behavior occurring about the error source and the type of error. On occurrence of an error the transition into a safe state is made possible.

These types of redundant embodiment are complicated and expensive simply because of the comparison electronics required and the duplicated arrangement of devices.

To reduce the complexity of the layout, solutions are known in which arranging the pick-up device supplying the measured values in the appropriate way makes it possible to undertake the determination of the measured values on the basis of only one pick-up device with error protection and without loss of accuracy. The lower number of components installed also reduces the error probability. This means that the availability of the system in which the drive is installed is also increased.

### SUMMARY OF INVENTION

An object of the invention is to make possible, compared to such arrangements, a further simplification and cost reduction for error-protected detection of the measured values and the transition into a safe state. The error protection of the system is not to be reduced in such cases.

This object is achieved by an inventive device and by an inventive method.

A device for error-protected detection of measured values in a control unit features a pick-up device to detect measuring signals. Evaluation devices operating independently of one another are provided for redundant determination of measured values from the measuring signals of the pick-up device. In addition the data is transmitted to the control unit by means of error-protected transmission equipment. In accordance with the invention a first evaluation device is provided for determining a measured value and a second evaluation device for determining a coarse comparison value of lower accuracy. In addition at least one device is provided for establishing that the measured values are error free by checking them against the comparison value. In accordance with a developed embodiment two devices are provided, which preferably check each other.

The second evaluation device thus does not perform any complete determination of the exact measured value. Only the signals of the pick-up device are evaluated and a coarse comparison value generated. The plausibility of the measured value can continue to be checked by the comparison value, error causes can continue to be determined as a result of deviations of measured value and comparison value. On the other hand the required evaluation logic is much simpler and more cost effective to implement than an evaluation with high accuracy. A complete independence of the evaluations is also guaranteed.

This method of operation is especially useful, if, as a result of the data volumes occurring, the evaluation of the measuring signals and the detection is to be performed with great accuracy while the computing time available is very small. In these cases the evaluation unit for determining the measured values is especially complex and cost-intensive, and on the other hand also especially error-prone. In this case the independent second evaluation unit, which only delivers a coarse comparison value, allows a reduction in costs to be obtained.

Nor does the inventive device require a device for undertaking voting between the measured values determined by two equally-ranked devices, which means a further reduction in costs.

There is provision in an advantageous embodiment of the invention for the first and second evaluation device to be embodied in the area of the pick-up device. A transmission device is used for error-protected transmission of the comparison value and of the measured value. The at least one device for establishing that no errors exist is provided in a control unit located away from the pick-up device.

In this way the signal transmission of the measuring signals of the pick-up device can be reduced in a simple manner to a short distance and then the measured values and comparison values determined can be transmitted without errors in a digital form and using the appropriate protocol, so that no errors can be induced on the transmission link or any such errors which do occur can be securely detected.

In a further embodiment of the invention there is provision that, in addition to measured value and comparison value a check value is measured which detects a periodically recurring reference position. The recording of a reference position, which in particular recurs periodically, such as for example the zero position of a rotating shaft, is possible with simple generators and without any great measurement evaluation, but is normally not sufficient for precise determination of the rotational speed or the position of a shaft, since the signal frequency is not sufficient. However it does represent a simple option of null method measurement and a further signal checking.

In this case, In accordance with an advantageous embodiment of the invention, the pick-up device is a rotary pick-up device, especially that of a drive. With rotary pick-up devices it is usual to detect a small angle of rotation of a shaft, which is especially detected using a fine scale division over one rotation of the shaft by optical scanning, with a measurement pulse being generated in accordance with the scale division after specific angles of rotation, with said pulse being able to be evaluated. It corresponds to an alternative embodiment, if a correspondingly adapted arrangement is used with a linear control.

In a further embodiment of the invention the pick-up device features two or more independent sensors which create measuring signals which are correlated with one another. The redundancy of the pick-up device is replaced by two correlated signals in one pick-up device which is created especially by a predetermined position offset of the two sensors in the pick-up device. Accordingly the signal sequence of the two sensors is output with a specific offset, with the signal levels being able to be related to one another, in order to detect signal errors on the one hand and to increase the measurement accuracy of the pick-up device on the other hand.

In a further advantageous embodiment of invention there is provision for the sensors of the pick-up device to create measuring signals with different accuracy. This facilitates the independent detection of measurement signals by two sensors in the pick-up device so that one of the two sensors delivers less precise signals, for example by the associated scale division of an optical rotary pick-up device being kept smaller. This makes signal evaluation easier because signal speeds are lower, but accuracy is less. The correlation between the more accurate signals with the less accurate signals still produces a sufficiently precise and error-protected evaluation of the pick-up device signals. The measuring signal of the second less accurate sensor in particular can be used as a basis for determination of the comparison value.

In accordance with a developed embodiment of the invention the evaluation of the pick-up device signals is also undertaken at least in an external control device preferably linked in by means of a network, especially with error protected data transmission. The signal processing can in this case be undertaken in an intermediate converter which transforms the measurement signals into signals which can be processed digitally. This makes it possible to implement the measurement evaluation and the associated electronics in remote more protected areas which are subject to fewer faults and more favorable environmental conditions than the signals are processed in the vicinity of the pick-up device.

A method In accordance with the invention provides for an error-protected detection of measured values in a control unit. Measurement signals are generated in a pick-up device. In a first and a second evaluation unit measured values are determined from the measurement signals and the freedom from errors is then determined by comparing the measured values. There is provision in this case for one measured value to be determined in a first evaluation devices and a coarse comparison value of lower accuracy in the second evaluation unit. The measured value determined is validated by comparing it with the comparison value.

This simplifies the required signal evaluation without losing the freedom from errors of the measured value determined. Nor is there any loss of accuracy of the measured value. However the evaluation effort is reduced and the system downtime is also improved by saving on electronic components.

In accordance with an advantageous embodiment of the invention a control value is measured in addition to the measured values being detected, with said control value detecting a periodically recurring reference position, in which case a correlation between measured value and comparison value is undertaken by means of the control value. Signal recognition at a known position can be undertaken in a simple manner by using at the control value and in addition a proportion of errors can be detected. The reference position can in this case be detected significantly more easily and requires less effort than a more precise detection of measured values. In particular it can consist of a simple push-button which is actuated in a specific position.

In accordance with an advantageous embodiment of the invention the pick-up device features two or more sensors which detect measurement signals correlated to each other. The measured value is determined in this case by taking account of the correlation of the two measurement signals to each other so that in particular a better signal resolution or increased accuracy can be obtained. The determination of the comparison value is preferably undertaken without taking into account the correlations, which simplifies the evaluation.

In accordance with a preferred embodiment of the invention the measured values represent the angular position of a shaft, especially the shaft of a drive. To this end the sensors of the pick-up device preferably generate pulses as a function of the rotation of the shaft, with each of said pulses representing a specific angle of rotation. This type of measurement recording can also be executed optically in a simple manner and can be employed for measuring both the angle of rotation and also the speed of rotation.

In accordance with a developed embodiment of the invention the sensors of the pick-up device generate measurement signals of different accuracy. This reduces the outlay required for the second sensor, with no concomitant loss of measurement accuracy. The validation of the signal of the first pick-up device can still be executed and also the comparison value can be derived from the second measurement signal of lower resolution in a simple manner.

In accordance with an advantageous embodiment of the invention, on determination of the measured value in the first evaluation unit, a first comparison of measured value and coarse value is undertaken. This provides a qualitatively reliable first evaluation and the comparison value of lower accuracy is generated in two independent devices. This improves the reliability and the error analysis.

### BRIEF DESCRIPTION OF THE DRAWINGS

The invention is explained in greater detail as well below with reference to an exemplary embodiment shown in the drawing, in which the Figures are as follows:

FIG. 1 a schematic diagram of an inventive device; and

FIG. 2 a block diagram of the determination of measured value and comparison value.

### DETAILED DESCRIPTION OF INVENTION

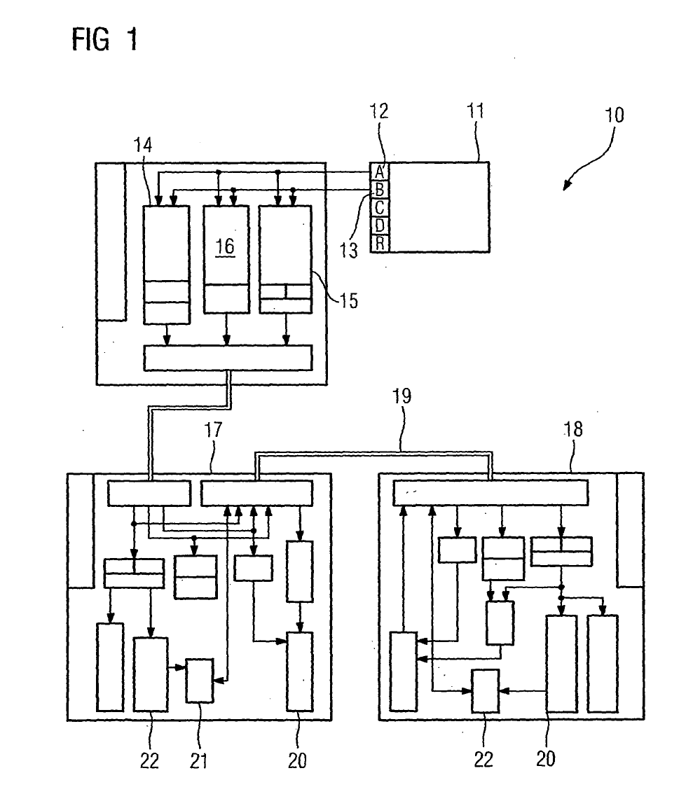

FIG. 1 shows a schematic diagram of a device 10 designed in accordance with the invention. A pick-up device 11 with two sensors 12 and 13 is provided. In this case the measurement signals of the two sensors 12, 13 are related to each other in a way determined by the arrangement of sensors, with said relationship being checked in a plausibility monitoring system. The signals of the sensors 12 and 13 are evaluated close to the pick-up device 11.

To this end the signals of the sensors 12 and 13 are evaluated in a first evaluation device 14 and a second evaluation device 15. In the first evaluation device 14 a measured value is determined whereas in the second evaluation device 15 the comparison value is determined with the correspondingly lower effort.

In addition the signal level is checked in the evaluation units in parallel to the signal evaluation. A plausibility checker is used for this purpose in which a check is made as to whether the signal levels of the two sensors 12 and 13 are in the correct relationship to each other. In particular a check is made as to whether the defined of set of the signals is produced which is the result of the positional relationship of the two sensors. With rotary generators it is possible for example to arrange the sensors in a specific offset to each other so that for example the signal levels of the two sensors 12, 13 are in a fixed relationship, in particular the squares of the signal levels can produce a constant value if the sensors are offset in an angular position of 90° to each other. If an error is identified during the plausibility checking the system goes into a safe state.

Measured value, comparison value and plausibility value are especially transmitted to the frequency converter using an error-protected data transmission device 17, especially a local data transmission bus. The protocol of the error-protected data transmission devices is especially chosen so that in the case of transmission errors the values can be re-created, meaning that redundancy is provided in the data record or errors can be established with certainty.

In a frequency converter 17 which is used in particular for the local execution of a regulation based on it setpoint values predetermined by a control unit 18, the transferred measured value is used for the regulation of monitored devices connected to the sensors 12 on 13, for example the drive of a rotating shaft. In addition measurement value, comparison value and plausibility value are transmitted to a remotely arranged control unit 18 via a data bus 19, with error-protected data transmission again being employed.

In the control unit 18 a comparison is undertaken between the measured value and the coarse position and the unit determines whether errors are present. If they are an alarm can be triggered with the warning device 20.

Both in the frequency converter 17 and also in the control unit 19 required values for movement monitoring, for example a standstill check, are determined from the measured value. The movement monitors 21 are used for this purpose. The actual values determined independently of one another are transferred in opposite directions over the data bus 19 and compared with each other in each case in a cross-comparison device 22 so that double redundancy is provided in the movement monitoring.

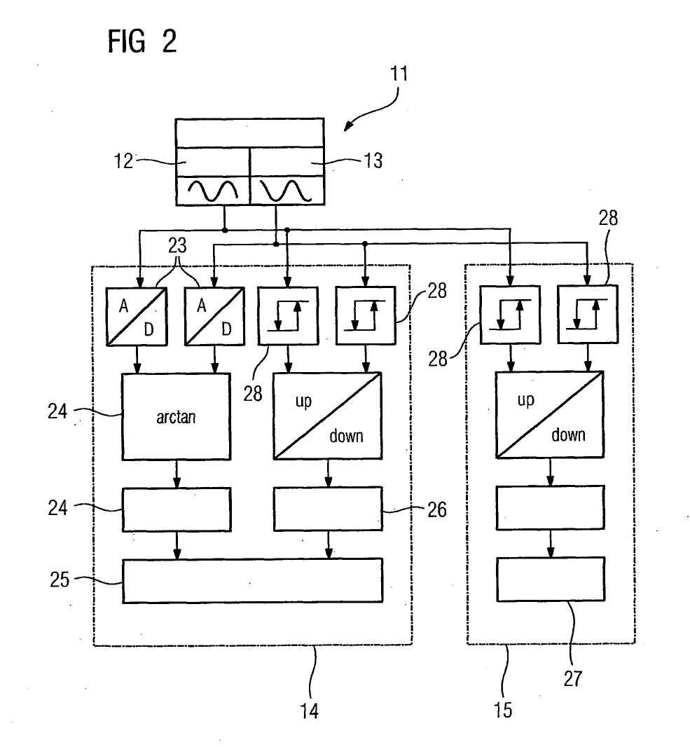

FIG. 2 shows the evaluation of the signals of the pick-up device 11. The pick-up up device has 2 sensors 12, 13 arranged in a specific position in relation to one another. Their signals are transferred both to the first evaluation device 14 and also to the second evaluation device 15.

In the first evaluation device, an analog-digital conversion 23 of the signals of the two sensors 12 and 13 is undertaken to determine the measured value. From a logical combination of the signals, taking into account the spatial position of the sensors 12, 13 in relation to one another, signal processing 24 is undertaken of which the result is the measured value 25. A first comparison value 27 is then assigned to this measured value 25 by which it is determined that an overshoot of a certain signal level 28 is monitored and is merged in a signal merging 26 to a first comparison value.

Independent of the determination of first comparison value, a second comparison value 27 is determined in the second evaluation unit, with a signal level monitoring 28 and a signal merging 26 again being undertaken in this unit. As a result of the evaluation a measured value 25 and the comparison value 27 are available.

1.-11. (canceled)

12. A device for error-protected detection of measured values in a control unit, comprising:
a pick-up device comprising a first independent sensor and a second independent sensor, the sensors effective for detecting measuring signals;
a first evaluation device effective for generating a measured value taking into account the correlation of the first and second measuring signals to each other;
a second evaluation device effective for generating a coarse comparison value of lower accuracy, the comparison value generated without taking into account the correlation;
a transmission device for error-protected transmission of data to the control unit; and
a checking device effective for establishing that the measure value is free from errors by checking the measured value against the comparison value.

13. The device as claimed in claim 12,
wherein the first and second evaluation devices are provided in an area of the pick-up device,
wherein the data transmission device is used for error-protected transmission of the measured value and of the comparison value, and
wherein the checking device for establishing the freedom from errors being provided in a control unit located away from the pick-up device.

14. The device as claimed in claim 12, wherein in addition to the measured value and the comparison value, a check value is measured which records a periodically recurring reference position.

15. The device as claimed in claim 12, wherein the pick-up device is a rotational pick-up device.

16. The device as claimed in claim 15, wherein the pick-up device is a rotational pick-up device of a drive.

17. The device as claimed in claim 12, wherein the first and second sensors create measuring signals of different accuracy.

18. The device as claimed in claim 12, wherein a plurality of measured values are evaluated in an external control device linked by a network.

19. The device as claimed in claim 18, wherein the network has an error-protected data transmission.

20. A method for error-protected detection of measured values in a control unit, comprising:
providing a pickup device having a first sensor generating a first measuring signal and a second sensor generating a second measuring signal;
providing a first evaluation unit and a second evaluation unit;
generating a measured value in the first evaluation unit taking into account a correlation of the first and second measuring signals;
generating a rough comparison value of lower accuracy in the second evaluation unit, the comparison value generated without taking into account the correlation of the first and second measuring signals; and
checking the measured value against the comparison value.

21. The method in accordance with claim 20,
wherein in addition to the measured value a check value is measured which detects a periodically recurring reference position, and
wherein a correlation being undertaken between measured value and the comparison value via the check value.

22. The method in accordance with claim 20,
wherein the measured value detects the angular positions of a shaft, and
wherein the sensors of the pick-up device create pulses depending on the rotation of the shaft, the pulses representing a specific angle of rotation in each case.

23. The method in accordance with claim 20, wherein the measured value detects the angular positions of a shaft of a drive.

24. The method in accordance with claim 20, wherein the sensors of the pick-up device generate measuring signals of different accuracy.

25. The method in accordance with claim 20, wherein to determine the measured value in the first evaluation device a first comparison of measured value and the comparison value is undertaken.
